(19) United States
(12) Patent Application Publication
(10) Pub. No.: US 2014/0237496 A1
(43) Pub. Date: Aug. 21, 2014

(54) Audience segment validation device and method

(71) Applicant: Effective Measure International Pty Ltd, Melbourne (AU)

(72) Inventor: Andrew Julian, Melbourne (AU)

(73) Assignee: EFFECTIVE MEASURE INTERNATIONAL PTY LTD, Melbourne (AU)

(21) Appl. No.: 14/182,729

(22) Filed: Feb. 18, 2014

Related U.S. Application Data
(60) Provisional application No. 61/765,840, filed on Feb. 18, 2013.

(51) Int. Cl. H04N 21/442; H04N 21/475

(52) U.S. Cl. CPC H04N 21/44213; H04N 21/4758
USPC 725/13; 725/14

(57) ABSTRACT

In one embodiment, a non-transitory computer-readable medium contains computer-executable instructions that, upon execution, result in the implementation of operations comprising: receiving from a third party data corresponding to a first collection of users, each user having first data associating the user to a first audience segment; acquiring or creating audience segment validation data using an audience segment validation method on the first collection of users; and transferring or presenting the audience segment validation data in a form of a collection of data or a report. The collection of data or the report may be transferred or presented to an advertiser, an advertising network, or an advertising agency. The audience segment validation method may comprise two or more methods selected from the group: querying a collection of user profile data, targeting users with queries, analyzing user behavioral data, and analyzing audience segment data from a plurality of data sources.

### TECHNICAL FIELD

The subject matter disclosed herein generally relates to digital advertising measurement and verification of audience segments and/or user data.

### BACKGROUND

In the area of digital advertising, whereby individual users access a multitude of content, applications and services on a variety of digital devices, it has become possible to segment individual users into certain groups that generalize their behavior, attitudes, demographics, psychographics and other attributes based on the actions they take on these digital devices. This segmentation of users, as used herein, is referred to as “audience segmentation”, and is used in the world of digital advertising to target messages at specific groups of users who have exhibited behavior which suggests that user may be part of the advertisers target market. These audience segmentation models are built and developed by independent third parties, often referred to as data exchanges or data providers. Audience segmentation can also be generated by first party data sources, such as an advertiser utilizing data from their own website, CRM or offline data sources that are synchronized to online cookies. The data provided by the data providers may be inaccurate, out-of date, generally of poor quality, or a poor representation of the attribute desired by the advertiser. Therefore, there is a need to validate the audience segmentation models from data providers.

### SUMMARY

In one embodiment, a non-transitory computer-readable medium contains computer-executable instructions that, upon execution, result in the implementation of operations comprising: receiving from a third party data corresponding to a first collection of users, each user having first data associating the user to a first audience segment; acquiring or creating audience segment validation data using an audience segment validation method on the first collection of users; and transferring or presenting the audience segment validation data in a form of a collection of data or a report. In one embodiment, the collection of data or the report is transferred or presented to an advertiser, an advertising network, or an advertising agency. In another embodiment, the collection of data or the report comprises audience segment validation data on a second collection of users provided by the advertiser, the advertising network, or the advertising agency. In a further embodiment, the audience segment validation method comprises two or more methods selected from the group: querying a collection of user profile data, targeting users with queries, analyzing user behavioral data, and analyzing audience segment data from a plurality of data sources.

In one embodiment, a computer implemented method for providing user validation data for users or validating users in an audience segment comprises transferring audience segment user data from one or more third party data sources to a second party; the second party acquiring or creating audience segment validation data using one or more audience segment validation methods selected from the group: querying a collection of user profile data, targeting users with queries, analyzing user behavioral data, and analyzing audience segment data from a plurality of data sources; storing the audience segment validation data on a first computer-readable storage medium; and the second party processing the audience segment validation data using a processor running a correlation algorithm stored on a second computer-readable storage medium, the processor outputting a collection of data or a report comprising the audience segment validation data acquired or created using the one or more audience segment validation methods.

In one embodiment, an audience validation system validates audience segment user data from one or more data providers by querying a subset sample of the users in the audience segment, analyzing or counting the declared responses submitted by the subset sample of the users in the audience segment, and reporting and/or providing data on the subset sample. In one embodiment, the system is designed to collect and analyze the responses collected directly from a subset group of these users via a survey mechanism, whereby the survey mechanism targets a number of users from the audience segment and one or more questions are asked of those users that have been crafted to validate the audience segment assigned to those users. In one embodiment, the audience validation system implements a segment validating methodology applied to a particular user of a device or a user of multiple devices used for targeting online advertising. In this embodiment, the a method of validating the audience segment comprises acquiring audience segment user data, surveying a subset of these users in the audience and determining in a statistically significant manner the accuracy of the methodology applied to the broader group of users assigned to that audience segment, based on the responses to the survey received from the sample of users. In one embodiment, a computer implemented method for providing data related to validation of an audience segment comprises: selecting, providing, or otherwise transferring audience segment user data from one or more third party data sources or first party data sources; acquiring or creating user data based on one or more audience segment validation methods selected from the group: targeting a subset of users with queries, analyzing user behavioral data, and analyzing collective intelligence across multiple first or third party data providers; and reporting the data and/or analysis related to the users and audience segment.

### BRIEF DESCRIPTION OF THE DRAWINGS

FIG. 1 is a data flow diagram of view of one embodiment of a system for audience segment validation.

FIG. 2 is an enlarged data flow diagram of three servers shown in FIG. 1.

FIG. 3 is a data flow diagram of view of the fingerprint information user matching method using third party data from one embodiment of a system for audience segment validation.

### DETAILED DESCRIPTION

The features and other details of various embodiments will now be more particularly described. It will be understood that particular embodiments described herein are shown by way of illustration and not as limitations. The principal features can be employed in various embodiments without departing from the scope.

### DEFINITIONS

“Computer-readable storage medium” comprises all types of computer-readable media, with the sole exception of the medium being a transitory, propagating signal.

In one embodiment, a non-transitory computer-readable medium contains computer-executable instructions that, upon execution, result in the implementation of operations comprising: receiving data from a third party corresponding to a first collection of users, each user having data associating them to an audience segment; querying each user in a first subset of the first collection of users with at least one question, the topic of the at least one question associated with the user's inclusion in the audience segment, receiving responses from a second subset of the first subset of the first collection of users; wherein the responses from the second subset of the first subset of the first collection of users provides declared audience segment validation data of the second subset of the first subset of users to the audience segment. In another embodiment, the results of the audience segment validation include user data related to the audience segment and/or a report that provides inferred or declared audience validation data. In one embodiment, the collection of user data related to the audience segment and/or the report is provided to an advertiser, ad network, ad agency or other related participant in the online advertising campaign including but not limited to the publisher, data provider, demand side platform (DSP), supply side platform (SSP), ad exchange, ad optimizer, ad verifier, data consultant or other technology provider utilized in the execution of the campaign. In a further embodiment, the report further provides audience segment validation data on a second collection of users provided by the advertiser, the ad network, or the ad agency or other related participant in the online advertising campaign including but not limited to the publisher, data provider, demand side platform (DSP), supply side platform (SSP), ad exchange, ad optimizer, ad verifier, data consultant or other technology provider utilized in the execution of the campaign.

In one embodiment, a computer implemented method of providing third party audience segment validation data comprises a first processor receiving data from a third party corresponding to a collection of users, each user having data associating the user to an audience segment; a second processor querying each user in a first subset of the collection of users with at least one question, a topic of the at least one question associated with inclusion of the user in the audience segment; a third processor receiving responses to the at least one question from a second subset of the first subset of the collection of users; a fourth processor analyzing the responses; and a fifth processor generating a report or data file based on analyzing the responses, the report or data file comprising audience segment validation data for the second subset of the first subset of users. In another embodiment, at least two processors selected from the group: the first processor, the second processor, the third processor, the fourth processor, and the fifth processor are the same processor. In one embodiment, the third party is an advertiser, an advertising network, or an advertising agency and the collection of data or the report is transferred or presented to the third party.

In one embodiment, the computer implemented method of providing third party audience segment validation data comprises selecting one or more audience segment validation parameters for determining one or more report instances. In a further embodiment, the computer implemented method of providing third party audience segment validation data comprises transferring first party user-related data to the second party.

### Audience Segment User Data Input

In one embodiment, audience segment user data or user related data for targeting users is provided by one or more first party data sources. In this context, the first party can be one of an advertiser, ad network, ad agency, researcher, publisher, or other entity intending to target a user. In another embodiment, audience segment user data or user related data for targeting users is provided by a second party data source. In this context, the second party is the party targeting the users with a survey and/or the party providing the report and/or collection of data on the audience segment validation data. In another embodiment, the validation of the audience segment for users is performed by the second party, where the second party performs one or more of the audience segment validation methods selected from the group: querying a collection of user profile data, targeting users with queries, analyzing user behavioral data, and analyzing audience segment data from a plurality of data sources.

In one embodiment, the audience segment user data or user related data for targeting users is provided by a third party data source. In this context, the third party is a party different from the first and second party. In another embodiment, the third party data source provider comprises a data exchange or a third party data service provider or network.

In a further embodiment, the audience segment user data or user related data for targeting users is a combination of data from one or more selected from the group: first party data sources, second party data sources, and third party data sources. For example, a first party advertiser may submit user information obtained from their client's website to the second party for audience segment validation. In this example, the second party may also receive audience segment user data from a third party data source and target a survey to a sampling of the combination or intersection of the first party data source users and the third party data source users, or target surveys to samplings of the first party data source users and a sampling of the third party data source users individually. In another embodiment, the second party samples users from the second parties collection of user profile data. In these examples, the results, such as a percentage of replying users that provide declarations representing or inferring the property associated with the particular audience segment and analysis of the surveys may be provided to the first party or third party. Similarly, in another example, a second party may target a sampling of users from two or more third party audience data providers and compare and report to the first party the audience segment validation percentages of the two or more third party audience data providers. In another example, the second party could combine internal audience segment user data with third party audience segment user data to provide additional audience segment validation data.

### Method of Audience Segment User Data Transfer and Matching

In one embodiment, the user data (such as audience segment user data) is transferred to the second party in a form or method that allows the correlation (matching) or syncing between at least one selected from the group: the first party user data and the second party user data, the third party user data and the second party data, the first party user data and the third party user data. In one embodiment, the form or method of user data matching and transfer is one or more selected from the group: tag delivery; cookie syncing; and fingerprint transfer. More than one method may be used, for example, such as transferring cookie information and fingerprint transfer in a spreadsheet sent daily from a third party data provider server to a second party server.

### Tag Delivery Method for Audience Segment User Data Transfer and Matching

In any situation where a digital advertising campaign can be delivered to a user across any number of platforms (including websites, advertising networks, mobile applications, smart televisions, tablets, smartphones, personal computers, etc.) and combining any available technologies and third party platforms interacting to deliver the design and content of an advertisement (the ad creative), to a user, it is common practice to include additional tracking, measurement, and verification code with the ad creative delivered to the end-user. This code can come in the form of a simple image that renders as a 1×1 transparent pixel (commonly referred to as a “beacon”) or a more complicated piece of JavaScript or other code (such as for example Visual Basic Script) which is executed by the end-users browser. Both of these common methods of providing additional tracking or similar functionality will herein be referred to as a “tag” in the context of an advertising campaign. Tags and methods of using various tags are disclosed in U.S. patent application Ser. Nos. 13/161,408, and 12/162,666, and International Patent Application publication number WO2010042978, the entire contents of each are incorporated by reference herein.

### Tag Delivery and User Profile

In one embodiment, a tag can be delivered with an advertising campaign that is capable of accepting a number of additional parameters that can be set specifically relative to one or more parameters of the individual campaign, ad creative, ad network, demand side platform, data provider, and data segments used for targeting that particular advertising impression.

In one embodiment, the data passed to the tag in the form of these additional parameters is accepted and processed by the computer systems and apparatus and can either be recorded in the user's browser (using for example, one or more selected from the group: first party cookies, third party cookies, Local Shared Objects, and Flash® Local Shared Objects) on a computer-readable storage medium, or in a computer readable storage medium on the server that can be looked up against using a unique identification (ID) assigned to a user and stored in their browser (using for example, one or more selected from the group: first party cookies, third party cookies, Local Shared Objects, and Flash® Local Shared Objects on a computer readable storage medium) or a device fingerprint ID that can be determined by running one or more points of data through a separate algorithm to identify the user in addition to or in the absence of cookies. Embodiments include storing the audience segmentation data for a user (and other parameters passed to the tag) in a profile associated with that user, either in the user's browser on the client side or in a server-side store keyed against an ID for the user. In one embodiment, the audience segmentation data for a user is stored in a “profile,” as used herein, irrespective of whether the data is stored in the user's browser (on computer readable storage medium) on the client side or a data storage mechanism on the server-side or off-site from the user. In another embodiment, an additional parameter accepted includes one or more user IDs determined by any third party, to facilitate synchronization of the insight gathered around the user back to a third parties own user data store.

### Cookie Synchronization Method for Audience Segment User Data Transfer and Matching

In one embodiment, the audience segment data is transferred from a first or third party to the second party by synchronizing cookies (also known as “cookie syncing”), user IDs, or synchronizing local shared objects. For example, in one embodiment, the third party user ID is sent from a third party data supplier in a browser based tagged transaction. In one example, the third party user IDs of the users in the desired audience segment can be synchronized against the user IDs of the second party. The synchronizing of the of the audience segment users may be performed in real-time or non-real-time (server-to-server) at a regular or non-regular time interval. For example, synchronizing of the audience segment users can be accomplished by electronically transferring audience segment user data comprising cookies from the third party to the second party using a spreadsheet file on a weekly basis, direct API connections in real-time or any other form of data transfer at any time interval specified as agreed by both parties.

In another embodiment, the cookie syncing process is facilitated by a JavaScript or Beacon tag call, where one or more parameters are transferred, such as only the sending parties' ID of the user in the audience segment, for example. In a further embodiment, a web bug is used to transfer one or more parameters, such as the sending party's ID of the user in the audience segment. A web bug is an object that is embedded in a web page or email and is usually invisible to the user but allows checking that a user has viewed the page or email. Web bugs are also known as web beacon, tracking bug, tag, or page tag. Common names for web bugs implemented through an embedded image include tracking pixel, pixel tag, 1×1 gif, and clear gif. When a web bug is implemented using JavaScript, they may be called JavaScript tags.

### Fingerprint Transfer Method for Audience Segment User Data Transfer and Matching

In one embodiment, the audience segment user information is transferred from the third and/or first party to the second party in the form of one or more identifiers, such as an ID, key, or other identifier, associated with a “fingerprint” of a user and the users are subsequently matched or correlated with other users. As used herein, a “fingerprint” is identifying information (or information that can be used to help identify) related to a device (a device fingerprint, also known as machine fingerprint) or browser (browser fingerprint) or other user-related identifying information associated with a user interacting with online information. In one embodiment, a third party or first party transfers fingerprint information corresponding to one or more audience segment users to the second party, the second party analyzes the fingerprint information using an algorithm (such as a correlation algorithm) to identify and match the user. Other input into the algorithm may include fingerprint information from the second party (such as device or browser fingerprint information), other fingerprint information, or other user related data that can be used to correlated the identity between the first party and/or third party audience segment user with the second party user information. In this embodiment, the user ID associated with the fingerprint information of the audience segment user and the ID associated with the second party user can be synchronized or correlated and used, for example, in a server-to-server information transfer without requiring cookie syncing or a tag.

Examples of user-related fingerprint information include, without limitation, information associated with or incorporated into: public hostname, public IP address, local area network IP address, public DNS IP address, operating system, user-agent browser, user-agent operating system, processor cores, screen size, screen resolution, color depth, time zone, system fonts, cookies enabled zombie cookie, regular cookie, web storage cookie, evercookie, standard HTTP cookie, cookies stored in and reading out web history, cookies stored in: HTTP ETags, Internet Explorer userData, HTML5 session storage, HTML5 local storage, HTML5 global storage, or HTML5 database storage via SQLite, storing cookies in RGB values of auto-generated, force-cached PNGs using HTML5 canvas tag to read pixels (cookies) back out, local shared objects (such as Flash cookies), Silverlight™ isolated storage cookies and plugin data, cookie syncing scripts that function as a cache cookie and re-spawn the MUID cookie, browser geolocation, IP geolocation, JavaScript data, JavaScript display data, request headers, Silverlight™ plugin data, Java plugin data, Flash® plugin data, TCP SYN Packet signature, browser plugin list, browser collected information including user agent, HTTP header, limited supercookie test information, and other information such as application or software information, JavaScript-collected information, client-side script information collected, driver information, other hardware or accessory identifying information or driver information, and any other information accessible that is stored on the client's computer-readable storage medium or on one or more server databases related to other user-identifying information. While it is understood that a cookie may be used to directly identify a user or cookie information could be used as an identifier (such as in the case of cookie syncing), within the context of user matching using fingerprint information, the existence of the cookie or information within the cookie combined with one or more other fingerprint related identifying information can be used to indirectly identify the user.

### Raw Fingerprint Data Transfer

In one embodiment, the third party or first party transfers the raw fingerprint information of the audience segment users to the second party. The data may be compressed or a shortened form or specifically selected fingerprint information may be transferred. In a further embodiment, the audience segment user information raw data or an unprocessed (not processed to create a key or identifier) portion thereof is transferred from the first party and/or third party to the second party and the second party correlates the received first party user fingerprint information and/or third party user fingerprint information with the second party user fingerprint information, or correlates the first party user fingerprint information with the third party user fingerprint information.

### Fingerprint ID or Fingerprint Key Transfer

In one embodiment, two or more types of fingerprint information are processed by a processor using a fingerprint algorithm to generate a shortened form of identification. In one embodiment, the shortened form of identification is a fingerprint identifier (ID) or fingerprint key generated by a fingerprint algorithm. In one embodiment, the fingerprint ID is a name (which may comprise a word, number, letter, symbol or any combination thereof) that identifies a unique user or class of users. In one embodiment, the fingerprint key comprises a word, number, letter, symbol or any combination thereof and is mapped to user data values using an associative array. In another embodiment, a hash table is used to implement the associative array of keys and user data values.

In one embodiment, the use of the fingerprint algorithm by the third party (and/or first party) and the second party speeds the identifying information transfer by only transferring a fingerprint key or fingerprint ID instead of a raw fingerprint information. In situations where cookies are deleted by the user for example, the cookie sync may not be reliable or accurate and fingerprint information, a fingerprint key, or a fingerprint ID may be more reliable.

### Fingerprint Algorithm

In another embodiment, the third party or first party uses a first fingerprint algorithm to generate a fingerprint key or fingerprint ID of the audience segment users and transfers the fingerprint key or ID to the second party. The fingerprint key or fingerprint ID may comprise encoded fingerprint information and/or the key or ID may be generated by a set of rules based on the entirety or a sub-set of possible fingerprint identification information available. In this example, the second party may use the fingerprint key or fingerprint ID, which may be a unique identifier, to correlate the audience segment user data received from the third party data provider with the second party user information (and/or the first party supplied user data). In one embodiment, this correlation may be achieved by a second party server running the fingerprint algorithm (which can be the same algorithm used by the first and/or third party) on first party or third party user fingerprint information to generate a fingerprint key or fingerprint ID that can be matched (or associated closely with a degree of certainty) with the fingerprint key or ID received from first party or third party or the fingerprint key or ID generated from the second party user fingerprint information.

In one embodiment, the audience segment user data transferred from the first party or second party comprises fingerprint information (in the form of raw data or a fingerprint key or fingerprint ID) and cookies for syncing some users. In another embodiment, the audience segment user data transferred from the first party or second party comprises fingerprint keys or fingerprint IDs and user cookie information for an audience segment. In this embodiment, some information corresponding to a user may only comprise a fingerprint ID (or fingerprint key), only comprise cookie data, or comprise a combination of fingerprint ID (or fingerprint key) and cookie data. In a further embodiment, the audience segment user data transferred from the first party or second party comprises a fingerprint ID processed by a fingerprint algorithm on a server that generates the fingerprint ID based on fingerprint information, user cookie information, or a combination thereof. For example, a third party server may process user data stored on a computer-readable storage medium using a fingerprint algorithm that generates one key corresponding to a user in an audience segment. In this example, the key could prioritize (or incorporate) cookie identification information and encode the information into the key. If, however, there is insufficient cookie information for user identification, the algorithm could create a key based on the fingerprint information available to the user in the audience segment. The fingerprint key could then be decoded and/or compared with other fingerprint keys stored on a computer-readable storage medium by the second party on a second party server.

In one embodiment, the fingerprint IDs or fingerprint keys are unique for a given collection of input fingerprint information associated with a user. In some situations, incomplete or conflicting fingerprint information can reduce the certainty of correlation. In one embodiment, a correlation algorithm is used to analyze the correlation of the users from two parties (such as correlating users from third party data providers with the second party or correlating users from the first party data provider and the third party data provider).

### Correlation Algorithm

In one embodiment, the second party runs a correlation algorithm on a correlation server that compares the fingerprint information, fingerprint key, or fingerprint ID received from the third party or first party with the second party fingerprint information, fingerprint key, or fingerprint ID, respectively, to match users. Thus, the correlation algorithm may compare the raw fingerprint information of users, the fingerprint keys of users, or the fingerprint IDs of users (and optionally cookie information if available). In one embodiment, the fingerprint key or fingerprint ID corresponding to the second party user data is generated by the second party using the same fingerprint algorithm (or by using the second party user fingerprint information directly). In one embodiment, the correlation algorithm compares the user data, fingerprint information, fingerprint keys, fingerprint IDs, or cookies and generates user correlation data and a confidence level, such as a 90% confidence level.

### Correlation Data

In one embodiment, the output from the correlation algorithm includes correlation data, such as a correlating match of 95% of the user data. In one embodiment, the matching of data is weighted differently for different fingerprint information categories. For example, a match of device hardware fingerprint information of user IP geolocation for a non-mobile device for a user may carry more weight than a match of display resolution or a mismatch of a cookie reading website visitation history since they can be readily changed by users. In one embodiment, the correlation data (weighted or un-weighted) for an audience segment user is in the form of a scale, such as a percentage from 0% to 100% or a scale from 1 to 100. In another embodiment the correlation data (weighted or un-weighted) for an audience segment user is in the form of a weighted match percentage or a statistical correlation parameter (such as a Pearson's product-moment coefficient), a rank correlation coefficient (such as Spearman's rank correlation coefficient or a Kendall's rank correlation coefficient), a distance correlation, a Brownian covariance, a correlation ratio, a polychoric correlation, or a coefficient of determination.

### Confidence Level of User Matching

In another embodiment, the output from the correlation algorithm includes confidence data, such as a 95% confidence level. In one embodiment, the fingerprint information for users with a high or higher correlation (or even a perfect match) is used to provide confidence (or increased confidence) on users with lower correlation or matching fingerprint information. For example, third party data comprising fingerprint IDs generated from a fingerprint algorithm corresponding to an audience segment is transferred to the second party. In this example, upon analysis of the fingerprint IDs (or an analysis of the decoded fingerprint information using a fingerprint decoding algorithm), the correlation algorithm (or separate algorithm) on the second party server notes that a particular user from the third party has a correlation of 90% (a straightforward match of 90% of the fingerprint information in this example) with a user in the second party's user database with a 92% confidence level. In particular, there is a user match with the geolocation in a high net-worth residential neighborhood, Beverly Hills, Calif. The correlation algorithm (or separate algorithm) can increase the confidence level of the match from, 92% to 94%, for example, by noting a strong correlation with perfect matches for other matched users with similar matching fingerprint categories (matching geolocation categories in this example). In this example, the correlation algorithm (or a separate algorithm) identified that 99% of the users from the delivered audience segment (or a historical data set of users) with a match of geolocation data were identified as accurate matches due to other data (such as a MAC address match, IP address match, or cookie sync, for example). Thus, in this example, the confidence level of the match can be increased from 92% to 94% due to the fact that the geotag location data of the third party provided data (in the form of a fingerprint ID) matched with the second party user data.

Continuing with the previous example, the correlation algorithm (or a separate algorithm) identified that 99% of the users from the delivered audience segment (or a historical data set of users) with a geotag location match of Beverly Hills, Calif. were identified as exact matches. Thus, in this example, the correlation algorithm can increase the confidence level above 94%, due to the specific information within the geotag location fingerprint information that matched the third party provided data (in the form of a fingerprint ID) with the second party user data. In another example, the correlation algorithm determines that there is a high degree of user matching (based on highly identifiable information such as a cookie) from a particular internet service provider (ISP) that can be identified by the public hostname fingerprint information. In this example, a particular ISP rarely changes the IP address associated with its users. The correlation algorithm can use this information (which it can determine independently from historical user-correlated data) and increase the confidence level for two user data sets with matching public IP addresses and matching public hostname information corresponding to this particular ISP.

Similarly, mismatch of key fingerprint category information (such as public IP address) may reduce the confidence level. Other extrapolations and modifications to the correlation or match may be drawn due to the content of the fingerprint information. The matching or mismatching of one or more fingerprint information categories or the specific information within the category that matched or did not match can increase or decrease the confidence interval range for the confidence level associated with matching the users.

In one embodiment, the confidence level information based on the provided audience segment user data or historical data on user matches (such as where direct matches via cookie syncing can be ascertained or a 99.99% fingerprint information match, for example) provides or contributes to the weighting of the fingerprint data for the correlation algorithm.

In one embodiment, the correlation algorithm produces an output metric that is a combination of user correlation data and confidence level, where the confidence level or the correlation data may rely on the provided instance of a collection of fingerprint information for users and/or historically provided user data such as historical user matching data from one or more user matching methods.

### Fingerprint Decoding

In one embodiment, the second party correlates the fingerprint key or ID received by the third party or first party by running a fingerprint decoding algorithm on the fingerprint key or fingerprint ID to recreate a portion or all of the fingerprint information and correlating the resulting fingerprint information with second party user fingerprint information and/or first party user fingerprint information. In one embodiment, the fingerprint decoding algorithm comprises two, more than two, or all of the fingerprint algorithm operations in a substantially reverse order such that at least a portion of the original fingerprint information is generated from the fingerprint key or ID.

### Combination of Audience Segment User Matching and Data Transfer Methods

In another embodiment, the user matching and data transfer method from the third party and/or first party to the second party is a combination of fingerprint IDs (or fingerprint keys) and cookie information for user synchronization. In another embodiment, the user data transfer and user data matching method for user data from the third party and/or first party to the second party is a combination of fingerprint transfer and tag delivery.

### Location of the Fingerprint Algorithm Server

In one embodiment, the fingerprint algorithm is processed on a first party server or a third party server. In another embodiment, a second party server processes the fingerprint algorithm. In another embodiment, a second party server processes the fingerprint algorithm and the first party and/or second party may call or use the fingerprint algorithm on the second party server.

### Frequency of Audience Segment User Data Transfer

In a further embodiment, some or all of the other parameters and data (such as fingerprint information or cookie information for cookie syncing) for one or more users is passed to the second party by one or more non-real-time, server-to-server transfers that can be performed once, on-demand, or periodically. This periodic transfer may be achieved through a direct or indirect connection between the servers of two parties. In another embodiment, the data is transferred in real-time (as the user navigates a website, for example), at a regular time (such as a regular time of the minute, hour, day, week, or month for example) or at a particular or predetermined time or interval.

### Selection of User-Matching Procedure or Parameters

In one embodiment, the first party, second party, or third party selects one or more user data and transfer and matching methods selected from the group: tag delivery; cookie syncing; fingerprint transfer; a party-defined matching method; or a combination of two or more of the previous matching methods. In another embodiment, the first party, second party, or third party selects one or more parameters selected from the group: correlation value; confidence level; confidence interval range; fingerprint algorithm (or sub-process of the fingerprint algorithm); correlation algorithm (or procedures or parameters within the correlation algorithm); correlation algorithm output metric; and fingerprint information to be used for user matching.

### Methods of Validating Audience Segments

In one embodiment, the method of validating audience segment for a user comprises one or more methods selected from the group: querying a collection of profile data; targeting users with a survey; analyzing behavioral data; and analyzing collective intelligence.

### Audience Segment Validation Input Parameters

In one embodiment, one or more of the first party, the second party, or the third party selects, inputs, calculates, generates, or predetermines one or more parameters related to the audience segment validation process selected from the group: one or more data sources (such as one or more third party data sources or a third party data source in combination with first party user data information, for example); one or more audience segment groups (such as combining two audience segment groups from the same third party data source and optionally targeting the users with two questions that provide two audience segment declarations in one query instance, for example); one or more audience segment sub-groups; the sample size of users; the percentage of users to be sampled; a confidence level; a confidence interval range for the queries; data analysis method; data analysis method parameters; data analysis comparisons (such as comparing two audience segments from the same provider or comparing the analyzed audience segment validation data against an average audience segment validation percentage of one or more third party data providers); start time and date for acquiring source data; start time and date for queries; time period for one or more queries; duration of audience segment validation process; total time interval for queries; end date and/or time for queries; one or more questions for one or more query instances; cost-based limitation value for limitation of sample size; one or more query delivery locations (site(s), or publisher(s) to be used for the queries, for example); one or more query delivery methods (such as, for example tag, type of tag, type of cookie used, etc.); number of reports; report type (for example, html, xml, PDF document, xls type spreadsheet, etc.); time or time interval for multiple report instances; and one or more report recipients.

### Audience Segment Validation by Querying a Collection of Profile Data

In one embodiment, a computer implemented method for providing information related to validation of an audience segment comprises: receiving audience segment profile information from one party corresponding to a first collection of users, each user in the first collection of users having first data associating the user to a first audience segment; querying a pool of user profile data of another party, the pool of user profile data comprising a second collection of users, each user in the second collection of users having second data associating the user to a second audience segment, the query comprising searching the second collection of users for users that match the first collection of users; generating audience segment validation data using the first data and the second data for the users within the second collection of users that match the users in the first collection users; and transferring or presenting audience segment validation data in the form of a collection of data or a report. In one embodiment, the audience segment validation data comprises data indicating that the first audience segment matches the second audience segment for one or more users within the second collection of users that match one or more users in the first collection of users. In another embodiment, the audience segment validation data comprises data indicating that the first audience segment does not match the second audience segment for one or more users within the second collection of users that match one or more users in the first collection of users. In a further embodiment, the audience segment validation data comprises data indicating that the first audience segment matches or does not match the second audience segment for one or more users within the second collection of users that match one or more users in the first collection of users.

Audience Segment Validation by Targeting Users with a Survey

In one embodiment, a computer implemented method for providing information related to validation of an audience segment comprises: receiving data from a third party corresponding to a first collection of users, each user having data associating them to an audience segment; querying each user in a first subset of the first collection of users with at least one question, the topic of the at least one question associated with the user's inclusion in the audience segment, and receiving responses from a second subset of the first subset of the first collection of users; wherein the responses to the queries from the second subset of the first subset of the first collection of users provides declared audience segment validation data of the second subset of the first subset of users to the audience segment.

In embodiment, a computer implemented method for providing information related to validation of an audience segment comprises: selecting or providing audience segment user data from one or more third party data sources; acquiring or creating data based on one or more audience segment validation methods selected from the group: querying a collection of user profile data; targeting users with queries, analyzing user behavioral data, and analyzing audience segment data from a plurality of data sources; and providing a collection of data or a report of the information related to the audience segment from the one or more audience segment validation methods. In one embodiment, the method for providing information related to audience segment validation further comprises selecting one or more audience segment validation parameters for determining one or more report instances.

In one embodiment, data is passed to a tag recorded in the user's profile. This data can be used in a subsequent process for targeting that user with a survey. As users browse around websites tagged with the tags additional logic can be triggered to look at the data in the profile and invite the users to complete a survey. Such tags and their use are disclosed in International Patent Application publication number WO2010042978, the entire contents are incorporated by reference herein. In one embodiment, this enables the capability to target a specific survey at specific data points recorded in one or more user profiles. In one embodiment, a user is targeted with two or more queries during a visit to a website to validate the user against two or more audience segments.

### Survey Questions

The survey served to these users can be one or more questions, whereby these questions are designed to validate the segment data used to target these users. Additional questions related to demographics, psychographics, attitudes, behaviors (including communication behaviors), product usage, and media use, etc. may also run as part of the survey to provide more insight into the sampled group of users. In one embodiment, the users are asked questions which are methodologically designed to validate the audience segment assigned to that user profile. In one particular example, but not encompassing all possible examples, and intended only as an indication of the type of survey questions that would be paired with one particular type of audience segment user data, a campaign may be purchased and executed against an “Auto Intender” segment whereby users had previously visited certain sites, certain parts of sites, submitted certain details to a form or any other measurable digital interaction or linking of non-digital offline data associated with a user with their digital profile, and these interactions had been determined by a company providing the audience segmentation data based on their external methodology as someone likely to be in the market for a new car. This audience segment cited in this example is arbitrary, and many others such as “Business Travelers” or “Grocery Shoppers” exist, and can be determined by first party or independent third party data providers varying methodologies. Other examples of audience segments cover a range of categories and can include, for example without limitation, gender, financial products, financial services, business, office, savings, electronics, entertainment, video games, hobbies, games and toys, cell phones, banking, checking, credit products, credit cards, financial services, financial planning, tax preparation, insurance, auto insurance, business insurance, health, health insurance, green living, home insurance, life insurance, recreational vehicle insurance, travel insurance, loans, auto loans, debt consolidation, home equity loans, money orders, mortgages, personal loans, refinancing, student loans, payroll and payment, retirement, investing, education savings accounts, IRA's, money market accounts, products, services, vehicles, boats, heavy equipment, motorcycles, campers, automobiles, automotive parts, new cars, used cars, education, financial aid, schools, babies, clothing, fashion and style, accessories, computers, garden, sports equipment, facilities, housing, restaurants, travel, hotels, employment, family composition, diet and fitness, financial attributes, housing attributes, language, marital status, and other categories.

In one embodiment, the audience segment validation device or method provides an additional capacity on top of those methodologies developed by third party data providers to help validate those inferred segments with declared data from a survey that samples a subset of those users. In the example of “Auto Intenders”, a survey may be configured with a single question (notwithstanding that multiple survey questions may be configured in other instances) that asks a sample of users “Are you in the market for a new car?” with two or more possible responses, perhaps in this instance simply “Yes” and “No”. In one embodiment, two or more queries are used to provide explicit or inferred data that may also be used to validate the audience segment.

### Sample Size for Queries

In one embodiment, a random sample of users are selected to respond and complete the survey (or a portion thereof) over a period of time to gradually fulfill a desired sample size. In one embodiment, the respondent sample size is greater than one selected from the group: 0.001%, 0.01%, 0.05%, 0.1%, 0.5%, 1%, 2%, 5%, 10%, 20%, 30%, 40%, 50%, 60%, 70%, and 80% of the total users in the audience segment. In another embodiment, the respondent sample size is less than or equal to one selected from the group: 0.001%, 0.01%, 0.05%, 0.1%, 0.5%, 1%, 2%, 5%, 10%, 20%, 30%, 40%, 50%, 60%, 70%, and 80% of the total users in the audience segment. In one embodiment, the respondent sample size is greater than one selected from the group: 1; 2; 5; 10; 50; 100; 200; 500; 1,000; 2,000; 5,000; 10,000; 100,000; 1,000,000; and 100,000,000 users in the audience segment. In a further embodiment, the respondent sample size is less than one selected from the group: 1; 2; 5; 10; 50; 100; 200; 500; 1,000; 2,000; 5,000; 10,000; 100,000; 1,000,000; and 100,000,000 users in the audience segment. In one embodiment, the sample size may vary based on input or selections by the first party, second party, third party, or other system users. In a further embodiment, the sampling may be continuous or on-going such that a real-time or progressive analysis of audience segment validation may be performed at party-selected, regular, predetermined, or random intervals or times.

In one embodiment, when the desired sample size or other audience segment validation parameter has been reached, the system will cease inviting users to complete the survey. In another embodiment, the sample size may be varying or a real-time analysis may wish to be performed to analyze the data as the responses are coming into the system. In one embodiment, for example, once the desired sample size has been reached, the system will stop inviting users to complete the survey, and the data collected for “Yes” and “No” responses (in this simple example) can then be aggregated and presented in a report to the advertiser as an indication of the accuracy of the audience segmentation methodology. For example, the report might state there were 2,000,000 users reached that were assigned to the “Auto Intender” segment of the third party data provider, 2,000 of those users were sampled and 87% of those sampled responded “Yes” to the question “Are you in the market for a new car?”. In one embodiment, the analysis of the audience segment provides a quantitative or qualitative understanding of the accuracy or related information of the audience segment that can be provided to the advertiser or other related party in various report forms or data.

### Confidence Level

In one embodiment, the number of queries is variable. In another embodiment, users are queried until the sample size of responding users reaches a first confidence level within a first confidence interval range. For example, in one embodiment, the desired first confidence level is 90% and the desired first confidence interval range is less than +/−5%. In this example, the users are queried until there is a 90% confidence level with a confidence interval range less than +/−5%. In this example, a sample of users in the “Auto Intender” audience segment are queried with a question asking them if they intend to purchase a new car in the next two months. The sample size is increased until there is a 90% confidence level with a less than +/−5% confidence interval range. In this example, when the number of users reached 2305, a 90% confidence level was reached with a confidence interval range of +/−4%. Thus, in this example, it was determined after sampling 2305 users that 66% of the users in the audience segment from the third party data source responded with a declared intent to purchase a car in the next two months. As a result of achieving the confidence level of 90% with a +/−5% confidence interval range, it can be inferred or estimated that if numerous additional sets of 2305 users were queried, the result would be 66%+/−4% for 90% of the sets. In one embodiment, the first confidence interval range is greater than one selected from the group: 40%, 50%, 60%, 70%, 80%, 90%, 95%, and 98%. In another embodiment, the first confidence interval range is between one selected from the group: −1% and 1%, −2% and 2%, −4% and 4%, −5% and 5%, −10% and 10%, −15% and 15%, and −20% and 20%.

### Queries Result Data

In one embodiment, the audience segment validation system provides the raw and/or modified collection of data including some or all respondents to the survey, potentially keyed against one or more third party user IDs sent to the system as part of the tag. In this embodiment, the information gathered from the users can be repurposed against any data held on those users (including all the actions originally used to segment those users). In one embodiment, the query responses are collected and analyzed to report on the percentage of replying users that provide declarations representing or inferring the property associated with the particular audience segment for validation. In another embodiment, the query response data is analyzed to provide confidence levels, confidence level intervals, reply rate data, or other statistically data represented graphically, tabular, or in another data presentation format suitable to the form used for the collection of data and/or report.

### Audience Segment Validation by Analyzing Behavioral Data

In one embodiment, an audience segment is validated by behavioral data acquired or inferred from one or more first party, second party, or third party data sources. For example, third party audience segment user data for an “Auto Intender” may be verified by actions taken on an automobile website by a user. One or more websites or sources from one or more providers may be used to collect behavioral data associated with users, including, for example an advertising client's website. This behavioral data may be analyzed by a second party processor, for example, to infer, suggest, confirm, or otherwise validate the user in one or more audience segments.

### Audience Segment Validation by Analyzing Collective Intelligence

In one embodiment, information related to the audience segment user data may be inferred by collecting information from two or more data sources, such as for example, three third party data sources or a first party data source and five third party data sources. In one embodiment, the audience validation system can be queried by a first party and receive information for a specific user provided by two or more third party data providers. For example, the analysis of data provided by five data providers may provide insight such as “3 out of 5 data providers have segmented this user as an ‘Auto Intender’” which can increase the validity, accuracy, or provide updated or related information. In one embodiment, one data source includes more recent data than a different source. In a further embodiment, the analysis of a user may comprise data from one or more audience segment user data providers and the results from the queries. In one embodiment, the data (or analysis and/or report on the data) includes data from one or more selected from the group: the results from one or more queries; behavioral data from one more users; the data from one or more third party data providers; data from the second party, and data from one or more first party data providers. In this embodiment, the increased number of data sources can illustrate and be used to improve the accuracy or provide validation related information on one or more selected from the group: the audience segment user data, data related to the audience segment; the quality of the third party data provider, the quality of the third party data providers data sources, the audience validation methodology, the audience validation system, and the audience validation queries.

### Audience Segment Validation Report or Collection of Data

In one embodiment, the results of the audience segment validation method are presented in a report and/or collection of data. In one embodiment, the information associated with the audience segment validation is collected and analyzed to report and/or provide collective data on the calculated, inferred, declared, or otherwise obtained information associated with the user belonging to one or more audience segments. In another embodiment, the information associated with the audience segment validation is analyzed to provide confidence levels, confidence level intervals, reply rate data, or other statistically data represented graphically, tabular, or in another data presentation format suitable to the form used for the collection of data and/or report. In one embodiment, the audience segment is validated against properties associated explicitly or directly with the defined audience segment by the audience segment validation method. For example, a sampling of users in the “Auto Intender” audience segment may be queried using the audience segment validation by targeting users with the query “Do you intend to purchase a vehicle in the next two months?” validating a direct correlation of the defined audience segment.

In another embodiment, the audience segment is measured against properties associated indirectly, inferred, or related to the defined audience segment by the audience segment validation method. The properties associated indirectly, inferred, or related to the defined audience segment can include sub-groups of an audience segment, predictive properties, or related properties. An example of predictive properties that can be analyzed by the audience segment validation method includes sending the query “Do you plan to update or obtain new automobile insurance in the next two months” to the “Auto Intender” audience segment to determine validity of the audience segment for the relationship between intent to buy a vehicle with intent to update or obtain new automobile insurance. In another example of predictive properties that can be analyzed by the audience segment validation method includes sending the query “Do you plan to update or obtain a new college savings account” to the “Babies” audience segment to determine validity of the audience segment for the relationship between intent to update or obtain new college savings with those with newborn babies. As an example of a related subgroup of an audience segment, a sampling of users in the “Auto Intender” audience segment may be queried using the audience segment validation by targeting users with the query “Do you intend to purchase a used vehicle in the next two months?” validating a sub-group correlation of “Used Car Intender” with the defined “Auto Intender” audience segment.

In another embodiment, the results of the audience segment validation method using targeted user queries are presented in a report and/or collection of data. The form of the report and/or collection of data can be in hardcopy or electronic form including, but not limited to, a webpage or portion thereof, PDF document, Microsoft Excel® file, CSV flat-file, Microsoft PowerPoint® presentation, Apache OpenOffice™ presentation file, or other presentation or visualization file format. In one embodiment the collection of data is transferred in the form of a Comma Separated Value (CSV) type file or in other formats suitable for a collection of data including JavaScript Object Notation (JSON)/Extensible Markup Language (XML) representations accessed via an Application Programming Interface (API) interface. In one embodiment, the data is presented in a format (such as a JSON/XML representation) that is programmatically accessible by a first party processor or third party processor such that the data can be viewed and/or analyzed on a granular level for each user sampled.

The report or collection of data can be delivered individually or as part of another report. In one embodiment, the audience segment validation data report and/or collection of data is presented within a broader software product suite to connect the quality and accuracy of the data (as determined by the methodology using an audience segment validation system) with the quality of the advertising campaign outcomes (which could be determined by other products offered by in the broader software product suite for validating uplift in brand awareness, product usage, sentiment etc.).

### Providing Raw Data

In one embodiment, the raw data from the audience segment validation including the query responses (and possibly information related to lack of response) is provided to the originating party, the first party data provider, or the third party data provider. In another embodiment, the second party provides the raw responses, related information, and optionally additional sampled (from a different query for a different audience segment, for example) or non-sampled user related information which the second party has otherwise obtained independent of the queries. Other information, aside from the actual responses, related to the queries and responses can include time and date of query, site location of query, number of queries, time of response, method of the response, speed of response, number of responses, response comments, delay between one or more responses, and other query or response related information.

For example, in response to an audience segment validation query of 2,000 users sampled from the pool of 2,000,000, a collection of data is transferred to the third party data provider including the third parties user ID along with the exact responses to the surveyed questions. This collection could also include additional user information on the users. For example, the additional user information could be responses from other queries, other data sources, or user information obtained from other third parties or using the second party's system. In one embodiment the information, such as the raw data with or without optional additional user information, transferred to the third party or second party is used to further refine the audience segmentation process or method. For example, the raw user data and related audience segment validation data transferred from the second party to the third party data provider can include user data on all of the queried users (those who answered yes, no, or did not respond, for example) which can increase the understanding of the users who answered “yes”, for example, as opposed to the users who said “no” on one or more particular queries, such as an audience segment defining query. The additional information provided can further improve the segmentation methodology or process.

### Hardware Implementation of Audience Segment Validation

One or more embodiments or methods for audience segment validation, user data matching, user data transfer, and audience segment validation methods, or sub-processes thereof may be implemented in one or more computer programs or algorithms, using one or more processors or servers, and may be carried by a computer readable storage medium, for example, a CD-ROM, a DVD, a flash memory device, a hard disk or so on, such programs being arranged to cause a server, processor, client device or other computer (in the broadest sense) to operate as described above. Similarly one or more embodiments may be implemented in an apparatus comprising a computer (in the broadest sense) set-up under the control of such programs to operate as described above.

### Result Recipients

In one embodiment, the first party advertisers, the first party ad network, the first party researcher, the first party publisher, or other first party entity intending to target a user receives the results of the audience segment validation system. In another embodiment, the third party data providers receive the results of the audience segment validation system. For example, the data could be used by the third party data provider to update the information on individual users or to assess the accuracy or quality of their data sources or to refine their segmentation methods.

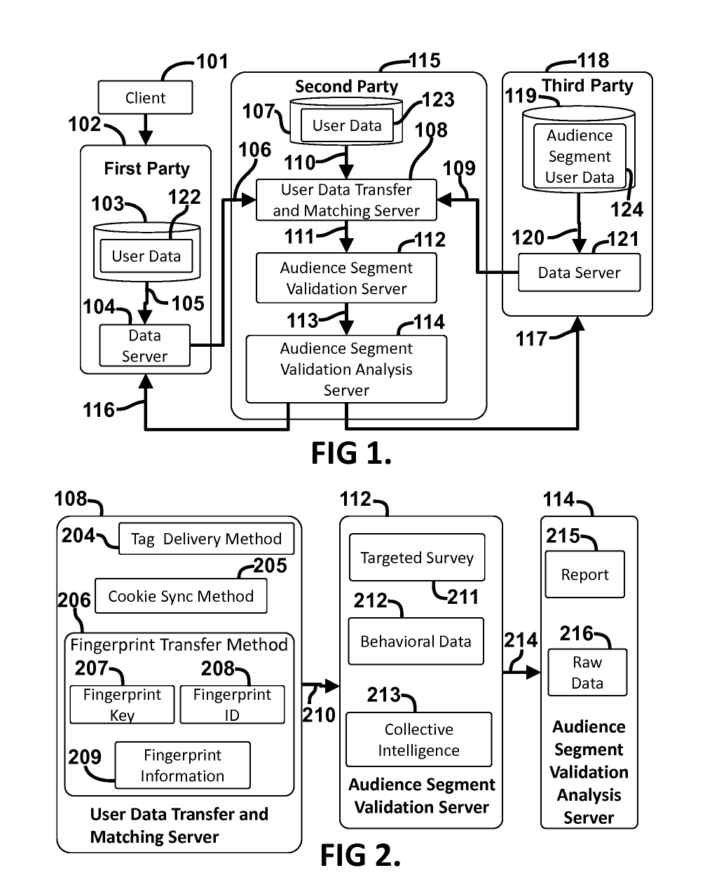

FIG. 1 is a data flow diagram of view of one embodiment of a system for audience segment validation. In this embodiment, user data 122 stored on a computer readable storage medium 103 with the first party 102 can be sent 105 to a data server 104 where it is transferred 106 to the User Data Transfer and Matching Sever 108 of the Second Party 115. In this embodiment, the first party 102 may receive user data from the client 101. Audience segment user data 124 stored on a computer readable storage medium 119 with the third party 118 can be sent 120 to a data server 121 where it is transferred 109 to the User Data Transfer and Matching Sever 108 of the Second Party 115. In this embodiment, the User Data Transfer and Matching Server 108 can receive user data input from one or more sources including the first party 102, the third party 118, or second party 115 user data 123 stored on a computer-readable storage medium 107 and transferred 110 to the User Data Transfer and Matching Server 108. The User Data Transfer and Matching Server 108 matches the users from two or more sources using one or more user matching methods (FIG. 2) and the matched user data is transferred 111 to the Audience Segment Validation Server 112. The Audience Segment Validation Server 112 validates the user segment data using one or more audience segment user validation methods (see FIG. 2) and the results are transferred 113 to the Audience Segment Validation Analysis Server 114. In the Audience Segment Validation Analysis Server 114 the analysis report and/or the raw data is transferred 116 to the first party 102 and/or transferred 117 to the third party 118.

FIG. 2 is an enlarged data flow diagram of three servers shown in FIG. 1 illustrating the methods or algorithms used by the User Data Transfer and Matching Server 108, Audience Segment Validation Server 112, and Audience Segment Validation Analysis Server 114. In this embodiment, one or a combination of user matching methods can be used to match users for audience segment validation. The User Data Transfer and Matching Server 108 can utilize one or more methods selected from the group: tag delivery method 204, cookie sync method 205, and fingerprint transfer method 206. If the fingerprint transfer method 206 is used, the data for matching the users may include one or more of a fingerprint key 207, fingerprint ID 208, and fingerprint information 209. The resulting matched user data from one or more matching methods is transferred 210 to the Audience Segment Validation Server 112. The Audience Segment Validation Server 112 can utilize one or more methods selected from the group: targeted survey 211, behavioral data 212, and collective intelligence 213 to provide validation or validation information for one or more users in the audience segment of interest. The validation information from the Audience Segment Validation Server 112 is transferred 214 to the Audience Segment Validation Analysis Server 114. The Audience Segment Validation Analysis Server 114 can provide an analysis or process the data from the Audience Segment Validation Server 112. The Audience Segment Validation Server 112 may validate the audience segment for one or more users using one or more audience segment validation methods selected from the group: querying a collection of user profile data, targeting users with queries, analyzing user behavioral data, and analyzing audience segment data from a plurality of data sources. Additionally, the Audience Segment Validation Server 112 may provide a report 215 and/or provide the raw data 216 to the third party 118 and/or the first party 102. In another embodiment, the Audience Segment Validation Server 112 transfers the raw data directly to the first party 102 and/or third party 118. In another embodiment, the Audience Segment Validation Server 112 analyzes the audience segment validation data and generates a report directly. In one embodiment, the user data is transferred by a first server and the user matching is processed by a second server.

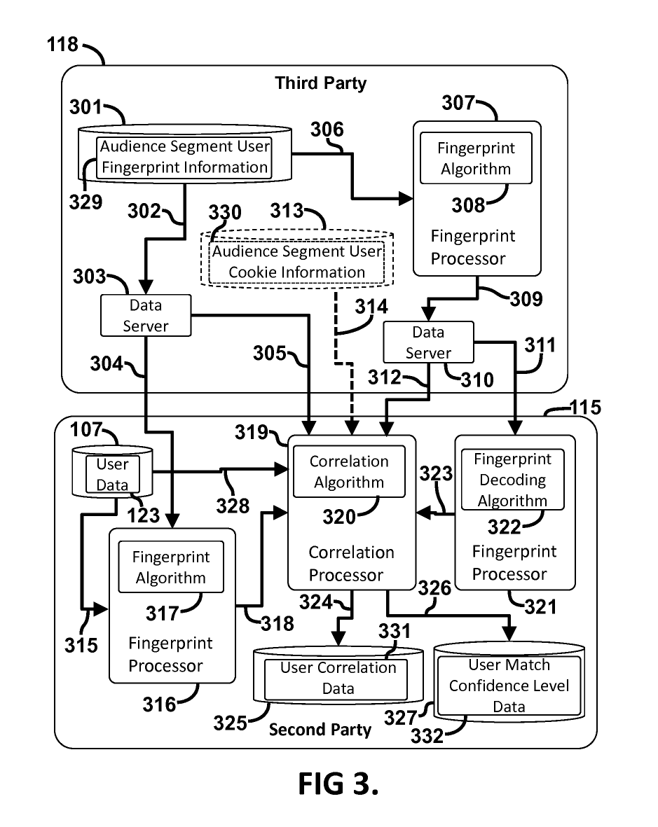

FIG. 3 is a data flow diagram of view of the fingerprint information user matching and data transfer method using third party data from one embodiment of a system for audience segment validation. In this embodiment, audience segment user fingerprint information 329 stored in the form of raw data on a computer-readable storage medium 301 may be transferred 302 to a data server 303 where it is transferred 304 to the second party fingerprint processor 316 or the second party correlation processor 319. Alternatively, the audience segment user fingerprint information 329 in the form of raw data stored on a computer-readable storage medium 301 may be transferred 306 to a third party fingerprint processor 307. The third party fingerprint processor 307 uses a fingerprint algorithm 308 to process the audience segment user fingerprint information 329 raw data and generate fingerprint keys or fingerprint IDs. The fingerprint keys or fingerprint IDs are transferred 309 from the fingerprint processor 309 to a data server 310 where they may be transferred 312 to the second party correlation processor 319 or the second party fingerprint processor 321 utilizing a fingerprint decoding algorithm 322. In the second party fingerprint processor 321 the fingerprint keys or fingerprint IDs are decoded to provide fingerprint information in the form of raw data that is transferred 323 to the second party correlation processor 319.

The audience segment user fingerprint information 329 in the form of raw data received by the second party fingerprint processor 316 is processed using a fingerprint algorithm 317 to generate fingerprint keys or fingerprint IDs. The fingerprint keys or fingerprint IDs are transferred 318 to the correlation processor 319. Second party user data 123 stored on a computer-readable storage medium 107 may be transferred 328 directly to the correlation processor 319 or may be transferred 315 to the fingerprint processor 316 where the fingerprint processor 316 generates fingerprint IDs or fingerprint keys using the fingerprint algorithm 317 that are transferred 318 to the correlation processor 319.

The correlation processor 319 can correlate fingerprint IDs or fingerprint keys for different users, including those transferred 318 from the second party fingerprint processor 316 or fingerprint keys or fingerprint IDs transferred 312 from the third party fingerprint processor 307 via the data server 310. The correlation processor uses a correlation algorithm 320 to generate user correlation data 331 transferred 324 to a computer-readable storage medium 325 and to generate user match confidence level data 332 transferred to a computer-readable storage medium 327.

Alternatively, the correlation processor 319 can correlate user fingerprint information 329 transferred 305 from the third party data server 303, user data 123 transferred 328 from the computer-readable storage medium 107, and fingerprint information decoded and transferred 323 from the second party fingerprint processor 321 comprising the fingerprint decoding algorithm 322. The correlation processor 319 can also correlated audience segment user cookie information 330 transferred 314 from a third party computer-readable storage medium 313 in addition to the fingerprint information raw data, fingerprint keys, or fingerprint IDs. Other embodiments include system configurations include where only fingerprint keys or fingerprint IDs are processed by the correlation processor or system configurations where only raw fingerprint information is correlated by the correlation processor.

### EQUIVALENTS

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. This application is intended to cover any adaptations or variations of the specific embodiments discussed herein. Therefore, it is intended that this disclosure be limited only by the claims and the equivalents thereof.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

What is claimed is:

1. A non-transitory computer-readable medium containing computer-executable instructions that, upon execution, result in the implementation of operations comprising:
a. receiving from a third party data corresponding to a first collection of users, each user having first data associating the user to a first audience segment;
b. acquiring or creating audience segment validation data using an audience segment validation method on the first collection of users; and
c. transferring or presenting the audience segment validation data in a form of a collection of data or a report.

2. The non-transitory computer-readable medium of claim 1 wherein the collection of data or the report is transferred or presented to an advertiser, an advertising network, or an advertising agency.

3. The non-transitory computer-readable medium of claim 2 wherein the collection of data or the report comprises audience segment validation data on a second collection of users provided by the advertiser, the advertising network, or the advertising agency.

4. The non-transitory computer-readable medium of claim 1 wherein the audience segment validation method comprises two or more methods selected from the group: querying a collection of user profile data, targeting users with queries, analyzing user behavioral data, and analyzing audience segment data from a plurality of data sources.

5. The non-transitory computer-readable medium of claim 1 wherein the audience segment validation method comprises:
a. querying each user in a first subset of the first collection of users with at least one question, a topic of the at least one question associated with inclusion of the user in the first audience segment; and
b. receiving responses to the at least one question from a second subset of the first subset of the first collection of users,
wherein the responses from the second subset of the first subset of the first collection of users provides declared audience segment validation data of the second subset of the first subset of users to the first audience segment.

6. The non-transitory computer-readable medium of claim 1 wherein the audience segment validation method comprises:
a. obtaining data relating to behavior of a first subset of the first collection of users; and
b. analyzing the data relating to the behavior and the first data and creating audience segment validation data that infers, suggests, confirms, or otherwise validates associating the first subset of the first collection of users to the first audience segment.

7. The non-transitory computer-readable medium of claim 6 wherein the behavior corresponds to validating the first subset of users in the first audience segment.

8. The non-transitory computer-readable medium of claim 1 wherein the audience segment validation method comprises:
a. receiving second data for a first user within the first collection of users from another party different than the third party, the second data associating the first user to a second audience segment; and
b. generating audience segment validation data for the first user by analyzing the first data and the second data.

9. The non-transitory computer-readable medium of claim 8 wherein the audience segment validation data comprises data indicating that the first audience segment matches the second audience segment for one or more users within the first collection of users.

10. The non-transitory computer-readable medium of claim 8 wherein the first data and second data are represented collectively in the audience segment validation data.

11. The non-transitory computer-readable medium of claim 1 wherein the audience segment validation method comprises:
a. querying a pool of user profile data of another party different from the third party, the pool of user profile data comprising a second collection of users, each user in the second collection of users having second data associating the user to a second audience segment, the querying comprising searching the second collection of users for users that match the users of the first collection of users; and
b. generating audience segment validation data using the first data and the second data for users within the second collection of users that match the users of the first collection users.

12. The non-transitory computer-readable medium of claim 11 wherein the audience segment validation data comprises data indicating that the first audience segment matches the second audience segment for one or more users within the second collection of users that match one or more users in the first collection of users.

13. A computer implemented method of providing third party audience segment validation data, the method comprising:
a. a first processor receiving data from a third party corresponding to a collection of users, each user having data associating the user to an audience segment;
b. a second processor querying each user in a first subset of the collection of users with at least one question, a topic of the at least one question associated with inclusion of the user in the audience segment;
c. a third processor receiving responses to the at least one question from a second subset of the first subset of the collection of users;
d. a fourth processor analyzing the responses; and
e. a fifth processor generating a report or data file based on analyzing the responses, the report or data file comprising audience segment validation data for the second subset of the first subset of users.

14. The computer implemented method of claim 13 wherein at least two processors selected from the group: the first processor, the second processor, the third processor, the fourth processor, and the fifth processor are the same processor.

15. The computer implemented method of claim 13 wherein the third party is an advertiser, an advertising network, or an advertising agency and the collection of data or the report is transferred or presented to the third party.

16. A computer implemented method of providing audience segment validation data, the computer implemented method comprising:
a. transferring audience segment user data from one or more third party data sources to a second party;
b. the second party acquiring or creating audience segment validation data using one or more audience segment validation methods selected from the group: querying a collection of user profile data, targeting users with queries, analyzing user behavioral data, and analyzing audience segment data from a plurality of data sources;
c. storing the audience segment validation data on a first computer-readable storage medium; and
d. the second party processing the audience segment validation data using a processor running a correlation algorithm stored on a second computer-readable storage medium, the processor outputting a collection of data or a report comprising the audience segment validation data acquired or created using the one or more audience segment validation methods.

17. The computer implemented method of claim 16 wherein the third party is an advertiser, an advertising network, or an advertising agency and the collection of data or the report is transferred or presented to the third party.

18. The computer implemented method of claim 16 wherein the method further comprises selecting one or more audience segment validation parameters for determining one or more report instances.

19. The computer implemented method of claim 16 wherein the method further comprises transferring audience segment user data from a first party to the second party.

20. The method of claim 16 wherein acquiring or creating audience segment validation data uses the audience segment validation method querying a collection of user profile data, the audience segment validation method querying the collection of the user profile data comprises:
a. querying each user in a first subset of a first collection of users in the audience segment user data with at least one question, a topic of the at least one question associated with inclusion of the user in a first audience segment; and
b. receiving responses to the at least one question from a second subset of the first subset of the first collection of users,
wherein the responses from the second subset of the first subset of the first collection of users provides declared audience segment validation data of the second subset of the first subset of users to the first audience segment.
